(19) United States
(12) Patent Application Publication
(10) Pub. No.: US 2012/0211565 A1
(43) Pub. Date: Aug. 23, 2012

(54) USER-ADAPTIVE PRESENTATION SCANNER

(75) Inventors: Stephen Colavito, Garnet Valley, PA (US); Thomas Amundsen, Turnersville, NJ (US); Michael Miraglia, Hamilton, NJ (US); Timothy Good, Clementon, NJ (US); Patrick Giordano, Glassboro, NJ (US)

(73) Assignee: Honeywell International, Inc. doing business as (d.b.a) Honeywell Scanning & Mobility, Fort Mill, SC (US)

(21) Appl. No.: 13/362,586

(22) Filed: Jan. 31, 2012

Related U.S. Application Data
(60) Provisional application No. 61/438,091, filed on Jan. 31, 2011.

(51) Int. Cl. G06K 7/14

(52) U.S. Cl. 235/462.36

(57) ABSTRACT

A system for collecting data is provided that includes a presentation scanning apparatus comprising a first presentation scan window formed into a housing. A first laser source within the housing is operable to emit a first beam through the first presentation scan window along a first axis and illuminate a target comprising an encoded symbol character. A first scanning mirror is disposed intermediate the first laser source and the first presentation scan window. The first scanning mirror is operable to deflect the first beam emitted from the first laser source so that the first beam scans across the presentation scan window according to a baseline scan pattern.

### CROSS REFERENCE TO RELATED APPLICATIONS

This application claims priority to U.S. Provisional Patent Application No. 61/438,091 filed Jan. 31, 2011 entitled, “User-Adaptive Presentation Scanner.” The above application is incorporated herein by reference in its entirety.

### FIELD OF THE INVENTION

This disclosure relates generally to presentation scanners and, more specifically, to user-adaptive presentation scanners.

### BACKGROUND OF THE INVENTION

Presentation bar code scanners are widely used at point-of-transaction workstations, for example in retail checkout settings such as supermarkets, warehouse clubs, department stores. Presentation bar code scanners, also known as flat bed laser readers or horizontal slot scanners, typically read one-dimensional bar code symbols, particularly of the Universal Product Code (UPC) type. The typical presentation bar code scanner includes a single, horizontal glass window built into and set flush with a horizontal checkout counter of the workstation. Products to be purchased have a bar code thereon and are typically slid across the horizontal window through which a multitude of scan lines are projected in a generally upwards direction. When at least one of the scan lines sweeps over the bar code associated with the product, the symbol is processed and read.

The multitude of scan lines are generated by a scan pattern generator which includes a laser source for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

A bioptic presentation scanner included in a point-of-transaction workstation includes a generally vertical scan window that faces an operator at the workstation. The vertical scan window is oriented perpendicularly to the horizontal scan window, or may be slightly rearwardly inclined. The scan pattern generator within the workstation also projects the multitude of scan lines in a generally outward direction through the vertical window toward the operator. The generator for the vertical window can be the same as or different from the generator for the horizontal window.

Sometimes, the vertical window is not built into the workstation as a permanent installation. Instead, a vertical slot scanner is configured as a portable reader which is placed on the countertop of an existing horizontal slot scanner.

Presentation scanners, and especially bioptic scanners, have dense scan patterns and large scan volumes that provide ease of use for even an untrained operator. However, scanning throughput can be improved by using proper swipe speed, proper orientation, and aiming for the “sweet spot” of the scan pattern. Often, an operator of a bar code scanner is trained in the proper use of the scanner in order to check out customers most efficiently. But, employee turnover in retail environments is often very high. Consequently, despite best efforts by management, not all employees get adequate training

In addition, many retail establishments have incorporated “self-checkout” lines in which the customers themselves present the bar coded products to the scan window. Self-checkout workstations provide little or no instruction to the operators. Hence, in both scenarios, inefficient scanner throughput is common and customer frustration can be high at the checkout line.

### SUMMARY OF THE INVENTION

A system for collecting data is provided that includes a presentation scanning apparatus comprising a first presentation scan window formed into a housing. A first laser source within the housing is operable to emit a first beam through the first presentation scan window along a first axis and illuminate a target comprising an encoded symbol character. A first scanning mirror is disposed intermediate the first laser source and the first presentation scan window. The first scanning mirror is operable to deflect the first beam emitted from the first laser source so that the first beam scans across the presentation scan window according to a baseline scan pattern. A first focusing apparatus in optical communication with the first laser source focuses the first beam on the target at a first object distance. The system further includes a first detector operable to receive light of varying intensities scattered from the encoded symbol character and convert the light into a first electrical signal, a digitizer operable to convert the first electrical signal to a digital bit stream, a decoder operable to receive the digital bit stream for decoding the first electrical signal, and a central processing unit adapted to monitor and record a first plurality of laser beam positions as the decoder decodes the encoded symbol character. The system further includes a memory coupled to the central processing unit. The memory stores a user profile associated with the first plurality of laser beam positions. The system is further adapted to alter the baseline scan pattern to a second scan pattern responsive to the user profile.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 is a perspective view of a retail point-of-transaction workstation according to one embodiment of the present invention;

FIG. 2 is a block schematic diagram of a presentation laser scanning system within the point-of-transaction workstation of FIG. 1;

FIG. 3 is a chart depicting historical data of a scanning mirror position for the presentation laser scanning system of FIG. 1;

FIG. 4 is a perspective view of a bioptic presentation scanner at a retail point-of-transaction workstation according to another embodiment of the present invention; and

FIG. 5 is a chart depicting historical data of a scanning mirror position for the bioptic presentation scanning system of FIG. 4.

FIGS. 6 and 7 are block diagrams illustrating exemplary bioptic scanners.

### DETAILED DESCRIPTION OF THE INVENTION

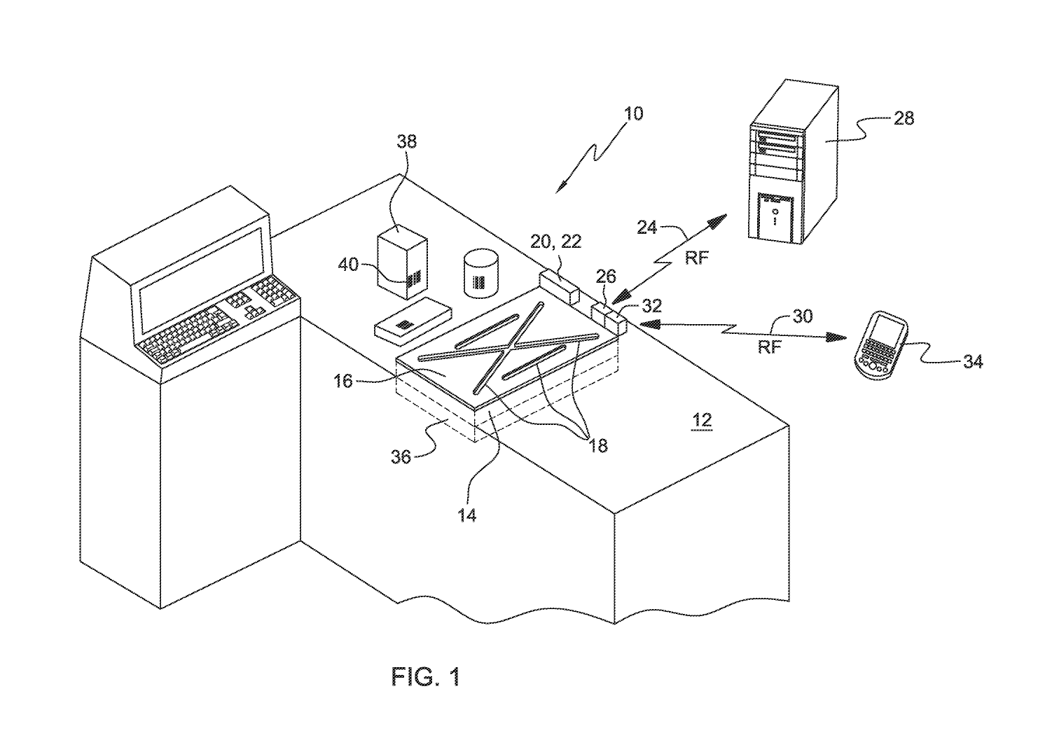

FIG. 1 illustrates a point-of-transaction workstation 10 used by retailers to process transactions involving the purchase of products bearing an encoded symbol character, typically a UPC symbol. The workstation 10 includes a horizontal countertop 12 for placement of products to be scanned. The countertop 12 includes an optically transparent (e.g., glass) horizontal scan window 14 mounted flush with the checkout counter, covered by a |_{[TG1]}window protection plate 16 which is provided with a pattern of apertures 18. The horizontal scan window 14 may be sized from half the width of the counter to the full width of the counter and approximately 12″-24″ long (along the length of the counter). In one embodiment, horizontal scan window 14 is provided without apertures 18. In one embodiment, horizontal scan window 14 is less than 12″ long. In one embodiment, horizontal scan window 14 is greater than 24″ long.

In some constructions, the workstation 10 may further include a radio frequency identification (RFID) reader 20; a credit card reader 22; a wide-area wireless interface (WIFI) 24 including RF transceiver and antenna 26 for connecting to the TCP/IP layer of the Internet as well as one or more storing and processing relational database management system (RDBMS) servers 28; a Bluetooth 2-way communication interface 30 including RF transceivers and antenna 32 for connecting to Bluetooth-enabled hand-held scanners, imagers, PDAs, portable computers and the like 34, for control, management, application and diagnostic purposes. The workstation 10 may further include an electronic weight scale module 36 employing one or more load cells positioned centrally below the system's structurally rigid platform for bearing and measuring substantially all of the weight of objects positioned on the scan window 14 or window protection plate 16, and generating electronic data representative of measured weight of such objects.

In use, an operator, such as a person working at a supermarket checkout counter, processes a product 38 bearing an encoded symbol character 40 thereon, past the horizontal scan window 14 by sliding the product past the window from right to left, or from left to right, in a “swipe” mode, or by presenting the bar code symbol on the product to the center of the window in a “presentation” mode. The choice depends on operator preference or on the layout of the workstation. If the encoded symbol character 40 is located on the bottom of the product, then one of the scan lines projected through the apertures 18 horizontal window 14 will traverse the symbol.

As used herein, “encoded symbol character” is intended to denote a representation of a unit of information in a message, such as the representation in a bar code symbology of a single alphanumeric character. One or more encoded symbol characters can be used to convey information, such as the identification of the source and the model of a product, for example in a UPC bar code that comprises twelve encoded symbol characters representing numerical digits. Also, an encoded symbol character may be a non-alphanumeric character that has an agreed upon conventional meaning, such as the elements comprising bars and spaces that are used to denote the start, the end, and the center of a UPC bar code. The bars and spaces used to encode a character as an encoded symbol are referred to generally as “elements.” For example an encoded character in a UPC symbol consists of four elements, two bars and two spaces. Similarly, encoded symbol characters can be defined for other bar code symbologies, such as other one-dimensional (“1-D”) bar code systems including Code 39 and Code 128, or for stacked two-dimensional (“2-D”) bar code systems including PDF417.

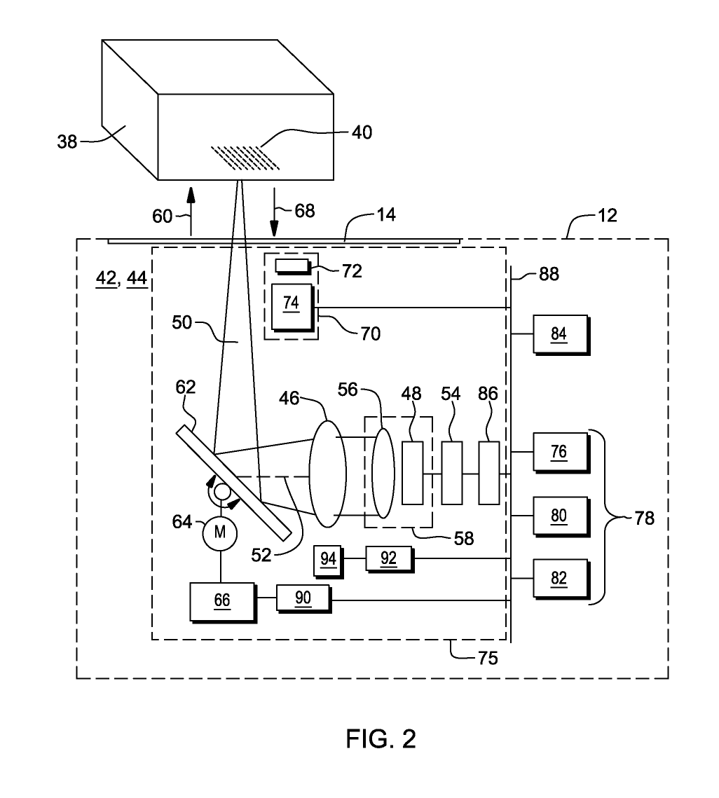

Referring to FIG. 2, a laser presentation scanner 42 mounts beneath the horizontal scan window 14 and projects a laser beam upwards through the glass. The laser presentation scanner 42 also be referred to as a laser scanner-based indicia reading terminal, or terminal 44. Although the illustrative system depicts a single scan source, in some constructions three or more scan sources can be utilized to provide a greater scan volume above the scan window 14. The terminal 44 includes a lens assembly 46, which may include a fixed lens, a variable position lens holder adapted for use with a moveable lens system, or a variable focus fluid lens, for example. The terminal 44 further includes a laser source 48 supported within the countertop 12. The laser source 48 can emit a laser beam 50 along an optical axis 52. Laser source 48 can be coupled to laser source control circuit 54. Light from laser source 48 can be shaped by collimating optics 56 and lens assembly 46. The combination of laser source 48 and collimating optics 56 can be regarded as a laser diode assembly 58. The laser beam travels in an emitting direction 60 along optical axis 52 and illuminates the product 38, which in one embodiment includes the encoded symbol character 40. A scanning mirror reflector 62 disposed within the optical path defined by axis 52 oscillates to direct the laser beam 50 across the entire surface to be scanned. The reflector 62 can be driven by scan motor 64 which is coupled to a control circuit 66. Although a single mirror is illustrated, the terminal 44 often includes many banks of mirrors, both stationary and moving. For example, in order to emit a laser beam through each of the apertures 18 (FIG. 1), a single laser source may be utilized with an array of splitting mirrors to emit multiple beams. The elements within dashed border 75 of FIG. 2 can be regarded as a laser scanning assembly 75.

The laser beam 50 reflects off the product 38 and travels along axis 52 in a receiving direction 68 back to a detector assembly 70. In the example wherein the product 38 includes a bar code, the incident laser light strikes areas of dark and white bands and is reflected. The reflected beam will thusly have variable intensity representative of the bar code pattern. The detector assembly 70 including detector 72 and analog to digital converter 74 can receive the reflected beam of variable intensity, generate an analog signal corresponding to the reflected beam, and convert it to a digital data set for storage into a system memory such as random access memory (RAM) 76. A memory 78 of terminal 44 can include RAM 76, a nonvolatile memory such as erasable programmable read only memory (EPROM) 80 and a storage memory device 82 such as may be provided by a flash memory or a hard drive memory. Central processing unit (CPU) 84 can be adapted to read out and process the digital data set stored within memory 78 in accordance with processing algorithms stored in the EPROM 80 or

RDBMS server 28, for example.

For attempting to decode a bar code symbol, CPU 84 can process a digitized signal corresponding to a scanned, reflected, and detected laser beam to determine a spatial pattern of dark cells and light cells and can convert each light and dark cell pattern determined into a character of character string via a table lookup. Terminal 44 can include various interface circuits allowing CPU 84 to communicate with various circuits of the laser scanner including first interface circuit 86 coupled to laser source control circuit 54 and system bus 88, second interface circuit 90 coupled to the scan motor control circuit 66, and third interface circuit 92 coupled to electrical power input unit 94.

Referring to FIGS. 1 and 2, the apertures 18 in the protection plate 16 and multiple laser sources and/or mirrors provide a sizeable scan volume in which the operator can swipe or present the product 38. Scanning throughput can be improved by using proper swipe speed, proper orientation, and aiming for the “sweet spot” of the scan pattern. However, without proper training, operators may experience difficulty in finding the best or most efficient location for scanning

According to one embodiment of the present invention, the system described herein is adapted to tailor the scan pattern to learned operator behavior, thereby increasing efficiency. According to the embodiment, the laser presentation scanner 42 “learns” a preferred or high probability scan pattern for the particular operator, and dynamically adjusts the scan pattern to prioritize future scanning to that scan pattern. The laser presentation scanner 42 can thus direct resources to a scan area or volume most likely to be chosen by the operator.

In one possible implementation, when a laser scan line encounters an encoded symbol character 40 (or a portion thereof), the position of the laser is recorded and stored in memory 78. Alternatively, the data can be stored in RDBMS server(s) 28 (FIG. 1). Over time, as positional data is collected as to the location of successful reads, a profile develops that indicates high probability locations. Such high probability locations may occur if, in one example, the operator tends to swipe in a repetitive manner at the same location, as may be seen with a left-handed operator, or a right-handed operator.

Recording the position of the laser can be realized in one example by coupling a trigger circuit to the detector assembly 70. When the detector 70 senses a change in voltage sufficient to characterize a bar code element, the trigger is tripped and a signal is relayed to the CPU 84, causing execution of code that records and stores in memory 78 the position of the scanning mirror reflector 62. In one embodiment a trigger circuit is provided by CPU 84 executing a program. For attempting to decode a bar code symbol, CPU 84 can process a digitized signal corresponding to a scanned, reflected, and detected laser beam to determine a spatial pattern of dark cells and light cells and can convert each light and dark cell pattern determined into a character of character string via a table lookup. Terminal 44 can be operative so that when a bar code symbol having a plurality of bar code elements is decoded CPU executes code to record and store in memory 78 a position of scanning mirror reflector 62. Terminal 44 can include various interface circuits allowing CPU 84 to communicate with various circuits of the laser scanner including first interface circuit 86 coupled to laser source control circuit 54 and system bus 88, second interface circuit 90 coupled to the scan motor control circuit 66, and third interface circuit 92 coupled to electrical power input unit 94.

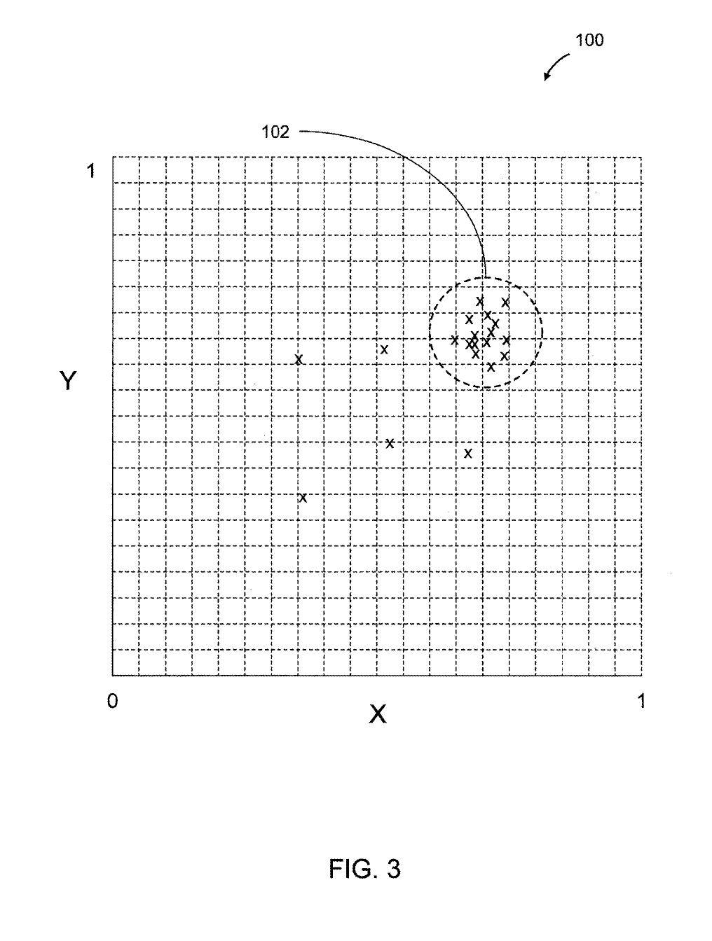

As feedback data is collected over time, it can display a profile unique for the particular operator. FIG. 3 is a chart 100 illustrating the normalized range of movements for the scanning mirror reflector 62 to achieve a baseline scan pattern. The mirror 62 moves in a first dimension (e.g. an X-plane) from a minimum distance 0 to a maximum distance 1. Likewise, the mirror 62 moves in a second dimension (e.g. a Y-plane) from a minimum distance 0 to a maximum distance 1. In an alternative embodiment, mirror 62 moves in a single dimension, e.g. an X-plane or Y-plane. The chart 100 is shown in 2-D, but could also include movements in a third plane (e.g., Z-plane), i.e. 3D coordinates resulting from movement of mirror reflector 62 in a third dimension. Historical data is plotted on chart 100 showing the positions of the scanning mirror reflector 62 when the detector 70 sensed a bar code element, as described above. A cluster or grouping of data points defines a profile 102 that meets probability criteria. The profile 102 can be mathematically generated using standard algorithms, such as histograms. Degrees of probability can be selected, such as two standard deviations, to define the profile 102. In the illustrated example, the profile 102 represents two standard deviations or approximately 95% of the data values.

In one embodiment, as set forth herein a user profile unique for a particular operation can be established by recording scanning mirror reflector positions responsively to a successful scans. In one embodiment, a user profile unique for a particular operation can be established alternatively or in addition by recording scanning mirror reflector positions responsively to unsuccessful scans (scans for which there is an unsuccessful attempt to decode). For example, if a scanner embodiment 100 scan lines and 50% of all successful scans were accomplished by lines 65 through 71, that would constitute a significant alternative to a standard uniform operator profile. Terminal 44 can be operative so that when a bar code symbol having a plurality of bar code elements is subject to a decode attempt and the attempt fails CPU 84 executes code to record and store in memory 78 a position of scanning mirror reflector 62.

The terminal 44 can alter the baseline scan pattern responsive to the profile 102. Using the profile 102 in FIG. 3 as an example, a second scan pattern can be configured that will direct the scan lines to the X-Y coordinates defined by the profile. In this manner, there is a greater probability (e.g. in one embodiment 95% probability) that the specific scan lines in the second scan pattern will detect the next bar code. The inventors have determined that the second scan pattern may encompass only a small fraction of the baseline scan pattern, for example, 25%. Thus, if a baseline scan pattern traverses over a baseline area of 100.0 cm², the second scan pattern can traverse an area of 25.0 cm². Thus, terminal 44 operates in a much more efficient manner by not having to scan the entire baseline area. The terminal 44 may be further configured to scan the second scan pattern for a predetermined period of time, or for a predetermined number of scans, for example.

In one embodiment as set forth herein, scanning mirror reflector 62 is adjusted in two dimensions. In another embodiment, plural scanning mirror reflectors are provided each one adjustable in a single dimension differentiated from the other, e.g. one in the X-plane, the other in the Y-plane. In another embodiment terminal 44 includes for directing light from a laser source 48 a single scanning mirror reflector adjustable in a single dimension.

In another embodiment, the baseline scan pattern is altered by increasing the speed of the scan motor 64 in the scan field defined by the user profile 102. This would have the effect of increasing the number of scans per second in the preferred area.

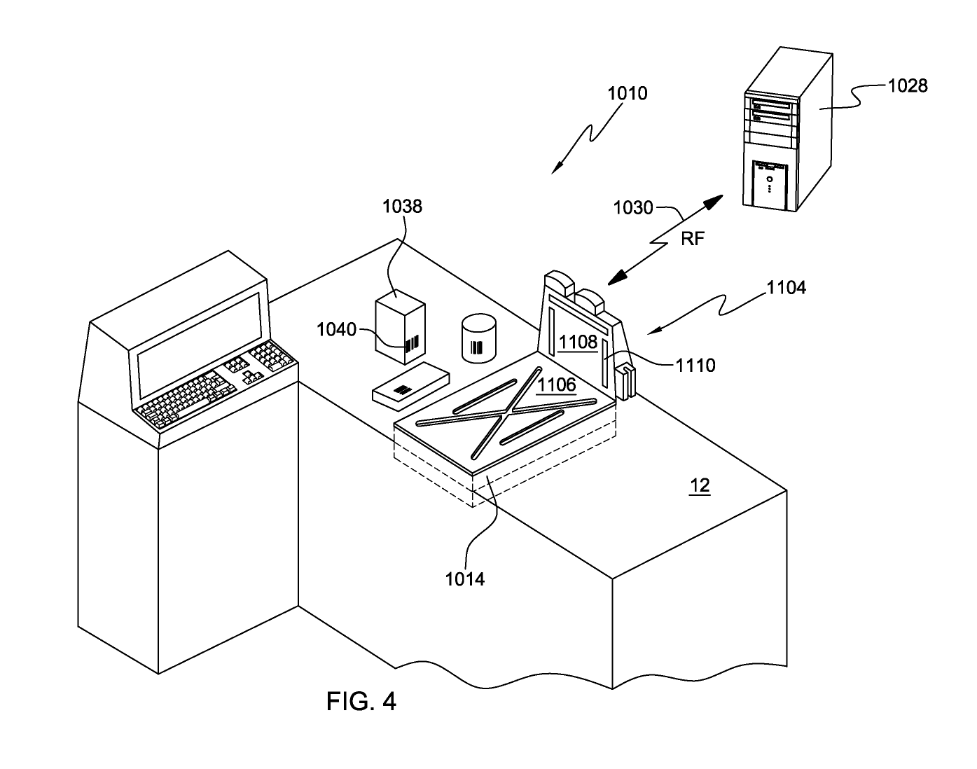

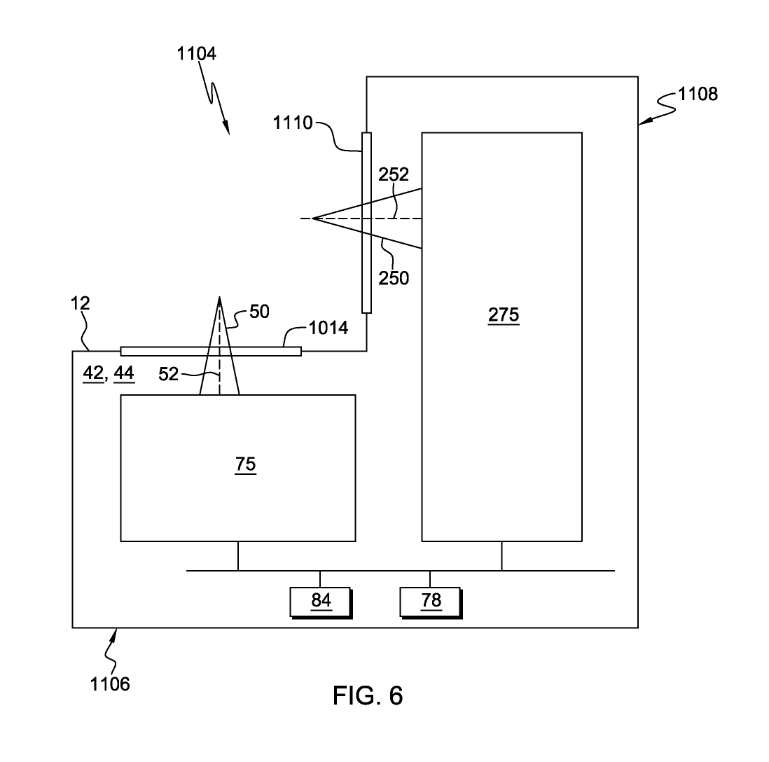

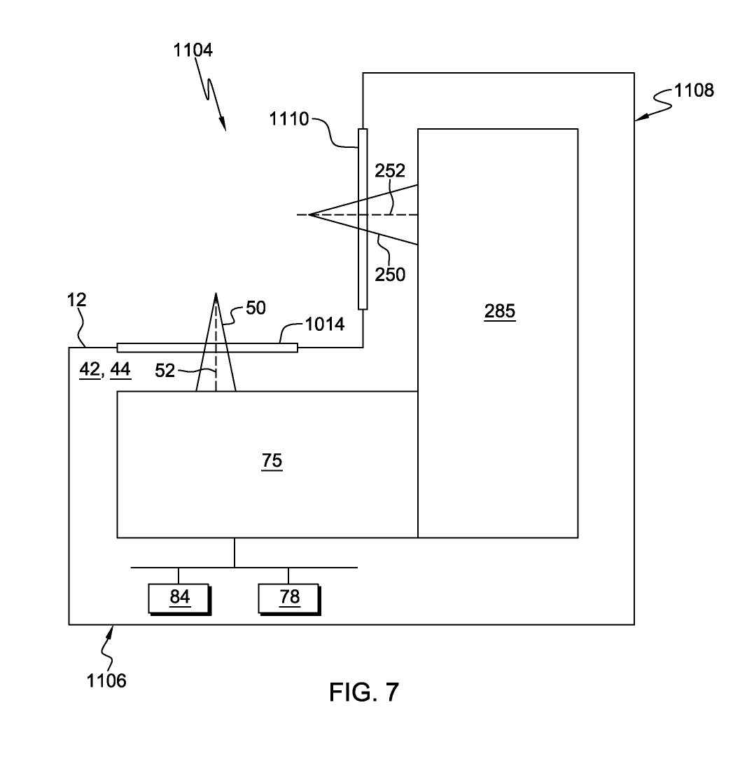

Referring to FIG. 4, a point-of-transaction workstation 1010 comprises a bioptic scanner 1104. The bioptic scanner 1104 includes two scanning planes, most commonly a housing having a first housing portion 1106 and a second housing portion 1108 which projects from one end of the first housing portion in a substantially orthogonal manner. When the bioptic scanner 1104 is installed within the countertop 12 surface, the first housing portion 1106 is oriented horizontally, whereas the second housing portion 1108 is oriented vertically with respect to the workstation. Thus, as referred to herein, the terms ‘first housing portion’ and ‘horizontally-disposed housing portion’ may be used interchangeably but refer to the same structure. Likewise, the terms ‘second housing portion’ and ‘vertically-disposed housing portion’ may be used interchangeably but refer to the same structure. A system having a second laser scanner assembly 275 is shown in FIG. 6. Second laser scanner assembly 275 can be constructed in the manner of and have the same components as laser scanner assembly 75, and can emit second beam 250 along axis 252 through vertical-scanning window 1110, with first beam 50 being emitted through horizontal scanning window 1014. In FIG. 7 there is shown a presentation scanning apparatus 44 having a series of splitting mirrors, i.e. a mirror assembly 285 to direct some of the laser light from the source in the horizontal portion through the vertical-scanning window 1110 in the second housing portion 1108.

The horizontal portion of the bioptic scanner 1104 shares much of the same construction as the laser scanner illustrated in FIG. 1. The bioptic scanner 1104 includes a horizontal scan window 1014 formed in the first housing portion 1106. A product 1038 having an encoded symbol character 1040 may be scanned by a scan source located in the first housing portion 1106. The bioptic scanner 1104 further includes a vertical-scanning window 1110 formed in the second housing portion 1108. The product 1038 may be alternately or simultaneously scanned by a second scan source in the second housing portion 1108. If the symbol 1040 is located on the side of the product, then one of the scan lines projected through the vertical-scanning window 1110 will traverse the symbol in the case the symbol is facing the vertical window. One or more of scan lines projected through horizontal scan window 1014 and scan lines projected through vertical scan window 1110 are likely to intersect a symbol of a product that is at a random orientation. The second scan source can be a separate laser scanner assembly or, as here, can include a series of splitting mirrors to direct some of the laser light from the source in the horizontal portion through the vertical-scanning window 1110 in the second housing portion 1108. In this manner, the functional block schematic diagram of FIG. 2 is substantially identical.

The baseline scan pattern of the bioptic scanner 1104 is substantially greater in area than the single-plane flat bed scanner because it is scanning dual planes. Because the scan pattern is larger (e.g., twice as large), the scanner 1104 outputs a far greater number of scan lines before returning to its original position. Thus, the bioptic scanner either appears to operate slower, or must consume more power to operate faster. Both configurations have drawbacks. In the configuration wherein two separate laser scanning assemblies are utilized, for example one in the horizontal scan window 1014 and one in vertical-scanning window 1110, twice the power, hardware, and resources are required, which also decreases efficiency.

According to another embodiment of the invention, a bioptic scanner is adapted to tailor the scan pattern to learned or known operator behavior, thereby increasing efficiency. According to one embodiment, the bioptic scanner 1104 “learns” a preferred or high probability scan pattern for the particular operator, and dynamically adjusts the scan pattern to prioritize future scanning to that scan pattern. The bioptic scanner 1104 can thus direct resources to a scan area or volume most likely to be chosen by the operator.

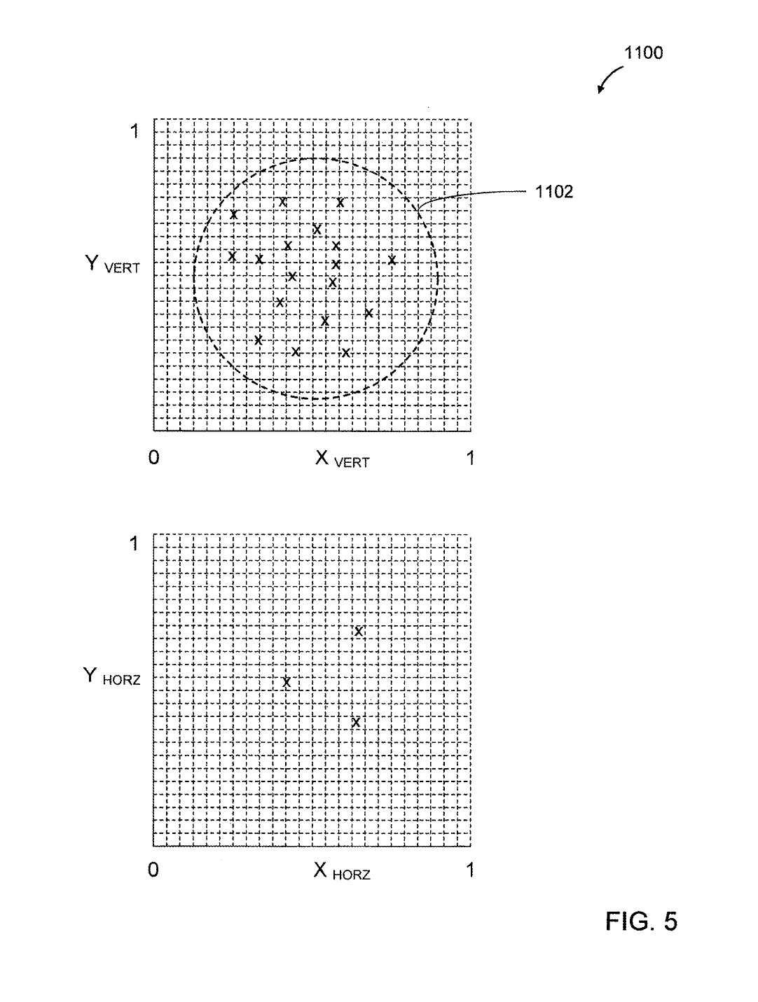

In one example, the operator tends to favor the vertical-scanning window 1110 over the horizontal scan window 1014. After a period of use, positional data on the scanning motor indicates that there exists a high probability future scans will be attempted at the vertical-scanning window 1110. The bioptic scanner 1104 can use that information to improve the scan performance in the vertical window 1110. Turning to FIG. 5, a chart 1100 illustrates the normalized range of movements for a scanning mirror reflector such as mirror 62 in FIG. 2 to achieve the baseline scan pattern for both the horizontal and vertical scan windows. Historical data plotted on chart 1100 depicts the positions of the scanning mirror reflector when the detector sensed a bar code element, as described above. The data suggests the particular operator uses the vertical-scanning window 1110 the majority of scans. Thus, a profile 1102 may be established associated with the laser beam position, as discerned from the scanning mirror movement, wherein the laser beam is most likely to be scanning the vertical scan window. The CPU 84 can be adapted to alter the scan pattern in response to the user profile 1102 by, for example, processing data from the vertical-scanning window 1110 first, before processing data from the horizontal scan window 1014.

In another example, the baseline scan pattern can be altered such that the CPU 84 spends more time attempting to decode data from the vertical-scanning window 1110 than data from the horizontal scan window 1014.

In yet another example, the baseline scan pattern can be altered such that more scan lines are performed for the vertical-scanning window 1110 to increase the pattern density. This may be implemented by activating a reserve scan channel, or by moving the scan mirror 62 in order to divert scan lines from the horizontal field 1014 to the vertical 1110, for example. In one possible implementation, one or more scan channels can be held in reserve for each scan window. Because the processing capability of the CPU 84 will have some finite limit, it may be necessary to turn off one scan field in the horizontal window for each reserve scan field that is activated in the vertical window. This approach would have the effect of shifting the scan pattern to the preferred window rather than just increasing the data processing need.

In the dynamic mode, mathematical algorithms such as histograms or standard deviations may be utilized to establish a profile. As such, the profile may change over time and the scan pattern may also change in response. For example, the data may strongly indicate the operator uses the vertical scan window, and the scan pattern can be adjusted accordingly to more efficiently use resources. However, if a new operator begins scanning, such as may be found in a self-checkout line, the data may quickly suggest the profile is outdated. Upon reaching predetermined limits, for example a predetermined number of consecutive scans outside the profile, the profile may be abandoned and data is collected for a possible new profile. In another example, the profile continues to evolve with the incoming data. The profile will generally result in the new scan pattern becoming larger in area, then eventually will reduce in size as better correlation is achieved with the operator.

According to another embodiment of the present invention, the system described herein is adapted to tailor the scan pattern to known or definitive operator behavior. In other words, rather than dynamically altering (in real time) the scan pattern in response to an operator's actions, the scan pattern may be altered manually, or preset. In one example, the bioptic scanner 1104 can be programmed according to the preferences of the operator. At the beginning of the operator's shift, a code could be input to the scanner designating the identity of the operator, and an associated profile could be retrieved from memory 78. The baseline scan pattern may be altered in response to the user profile, such as first scanning the vertical window. In another example, the laser scanner in the workstation could be set with a factory default scan pattern, and the particular retailer could have a preferred profile that alters the baseline scan pattern. In these examples, the profiles are hard-coded into the memory 78, rather than dynamically learning them (and changing them) during scanner operation.

In one embodiment, resources of terminal 44 are redirected without altering a scan pattern. For example, in one embodiment, a scan pattern of terminal 44 can be constant and unchanging responsively to a user profile but nevertheless, responsively to a user profile, terminal 44 can increase a frequency of decode attempts using data from a certain portion of the scan pattern relative to a remaining portion of the scan pattern.

One advantage of the disclosed presentation scanning apparatus is that it will adapt to the particular usage of the operator, rather than the operator having to learn the intricacies of the scanner, such as swipe speed, “sweet spot,” and orientation. By adapting to the user and adjusting the scan pattern accordingly, more efficient use of the scanner can be obtained, which increases throughput at the checkout line and averts customer frustration.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

A system for collecting data is provided that includes a presentation scanning apparatus comprising a first presentation scan window formed into a housing. A first laser source within the housing is operable to emit a first beam through the first presentation scan window along a first axis and illuminate a target comprising an encoded symbol character. A first scanning mirror is disposed intermediate the first laser source and the first presentation scan window. The first scanning mirror is operable to deflect the first beam emitted from the first laser source so that the first beam scans across the presentation scan window according to a baseline scan pattern. A first focusing apparatus in optical communication with the first laser source focuses the first beam on the target at a first object distance. The system further includes a first detector operable to receive light of varying intensities scattered from the encoded symbol character and convert the light into a first electrical signal, a digitizer operable to convert the first electrical signal to a digital bit stream, a decoder operable to receive the digital bit stream for decoding the first electrical signal, and a central processing unit adapted to monitor and record a first plurality of laser beam positions as the decoder decodes the encoded symbol character. The system further includes a memory coupled to the central processing unit. The memory stores a user profile associated with the first plurality of laser beam positions. The system is further adapted to alter the baseline scan pattern to a second scan pattern responsive to the user profile. In one embodiment, the presentation scanner is a bioptic scanner.

A sample of systems and methods that are described herein follows:

A system for collecting data, comprising:

a presentation scanning apparatus comprising a first presentation scan window formed into a housing, a first laser source within the housing operable to emit a first beam through the first presentation scan window along a first axis and illuminate a target comprising an encoded symbol character, a first scanning mirror disposed intermediate the first laser source and the first presentation scan window, the first scanning mirror operable to deflect the first beam emitted from the first laser source so that the first beam scans across the presentation scan window according to a baseline scan pattern, a first focusing apparatus in optical communication with the first laser source for focusing the first beam on the target at a first object distance, a first detector operable to receive light of varying intensities scattered from the encoded symbol character and convert the light into a first electrical signal, a digitizer operable to convert the first electrical signal to a digital bit stream, a decoder operable to receive the digital bit stream for decoding the first electrical signal, a central processing unit adapted to monitor and record a first plurality of laser beam positions as the decoder decodes the encoded symbol character; and

a memory coupled to the central processing unit, the memory for storing a user profile associated with the first plurality of laser beam positions;

wherein the system is further adapted to alter the baseline scan pattern to a second scan pattern responsive to the user profile.

The system of paragraph [0047], wherein the plurality of laser beam positions comprises positional data.

The system of paragraph [0048], wherein the positional data comprises positions of the first scanning mirror.

The system of paragraph [0049], wherein the central processing unit monitors a trigger circuit coupled to the first detector, the trigger circuit activated upon the detector sensing a change in voltage sufficient to characterize the encoded symbol character.

The system of paragraph [0047], wherein the second scan pattern encompasses a smaller area than the first scan pattern.

The system of paragraph [0047], wherein the second scan pattern encompasses less than 25 percent of the baseline scan pattern.

The system of paragraph [0047], wherein the user profile is stored in a relational database management system.

The system of paragraph [0047], wherein the baseline scan pattern is altered to the second scan pattern dynamically.

The system of paragraph [0047], wherein the baseline scan pattern is altered by increasing the speed of a motor coupled to the first scanning mirror, the speed increased while in the scan field defined by the user profile.

The system of paragraph [0047], wherein the baseline scan pattern is altered to the second scan pattern manually.

The system of paragraph [0056], wherein the second scan pattern is user-configurable.

The system of paragraph [0047], wherein the presentation scanning apparatus is a bioptic scanning apparatus, further comprising a second presentation scan window, the baseline scan pattern comprising the first and second scan windows.

The system of paragraph [0058], wherein the second presentation scan window projects orthogonally from the first presentation scan window.

The system of paragraph [0059], wherein the first presentation scan window is oriented horizontally and the second presentation scan window is oriented vertically.

The system of paragraph [0058], wherein the baseline scan pattern is altered by the central processing unit processing data from the first presentation scan window before processing data from the second presentation scan window.

The system of paragraph [0058], wherein the baseline scan pattern is altered by the central processing unit allotting more time attempting to decode data from the first presentation scan window than from the second presentation scan window.

The system of paragraph [0058], wherein the baseline scan pattern is altered by performing more scan lines on the first presentation scan window than the second presentation scan window to increase the pattern density on the first presentation scan window.

The system of paragraph [0063], wherein a reserve scan channel coupled to the first presentation scan window is activated by the central processing unit.

The system of paragraph [0064], wherein one scan channel in the second presentation scan window is turned off for each reserve scan channel that is activated in the first presentation scan window.

The system of paragraph [0063], wherein the central processing unit commands the first scanning mirror to divert scan lines from the first presentation scan window to the second presentation scan window.

1. A system for collecting data, comprising:
a presentation scanning apparatus comprising a first presentation scan window formed into a housing, a first laser source within the housing operable to emit a first beam through the first presentation scan window along a first axis and illuminate a target comprising an encoded symbol character, a first scanning mirror disposed intermediate the first laser source and the first presentation scan window, the first scanning mirror operable to deflect the first beam emitted from the first laser source so that the first beam scans across the presentation scan window, a first focusing apparatus in optical communication with the first laser source for focusing the first beam on the target at a first object distance, a first detector operable to receive light of varying intensities scattered from the encoded symbol character and convert the light into a first electrical signal, a digitizer operable to convert the first electrical signal to a digital bit stream, a decoder operable to receive the digital bit stream for decoding the first electrical signal, a central processing unit adapted to monitor and record a first plurality of laser beam positions as the decoder decodes the encoded symbol character; and
a memory coupled to the central processing unit, the memory for storing a user profile associated with the first plurality of laser beam positions;
wherein the system is further adapted to alter the operation of the presentation scanning apparatus responsive to the user profile.

2. The system of claim 1, wherein the plurality of laser beam positions comprises positional data.

3. The system of claim 2, wherein the positional data comprises positions of the first scanning mirror.

4. The system of claim 3, wherein the presentation scanning apparatus includes a trigger circuit activated upon the detector sensing a change in voltage sufficient to characterize the encoded symbol character.

5. The system of claim 1, wherein the presentation scanning apparatus is operable to store a position of the first scanning mirror when a bar code element is characterized by the presentation scanning apparatus.

6. The system of claim 1, wherein the presentation scanning apparatus for providing of the user profile is operable to store a position of the first scanning mirror when a bar code symbol is decoded by the presentation scanning apparatus.

7. The system of claim 1, wherein the presentation scanning apparatus for providing of the user profile is operable to store a position of the first scanning mirror when there is an unsuccessful attempt by the presentation scanning apparatus to decode a bar code symbol.

8. The system of claim 1, wherein the first scanning mirror is operable to deflect the first beam emitted from the first laser source so that the first beam scans across the presentation scan window according to a baseline scan pattern, and wherein the system is adapted to alter the baseline scan pattern to a second scan pattern responsive to the user profile, wherein the second scan pattern encompasses a smaller area than the first scan pattern.

9. The system of claim 8, wherein the second scan pattern encompasses less than 25 percent of the baseline scan pattern.

10. The system of claim 1, wherein the user profile is stored in a relational database management system.

11. The system of claim 8, wherein the baseline scan pattern is altered to the second scan pattern dynamically.

12. The system of claim 1, wherein the operation of the presentation scanning apparatus is altered by increasing the speed of a motor coupled to the first scanning mirror.

13. The system of claim 8, wherein the baseline scan pattern is altered to the second scan pattern manually.

14. The system of claim 13, wherein the second scan pattern is user-configurable.

15. The system of claim 1, wherein the presentation scanning apparatus is a bioptic scanning apparatus, further comprising a second presentation scan window, the baseline scan pattern comprising the first and second scan windows.

16. The system of claim 15, wherein the second presentation scan window projects orthogonally from the first presentation scan window.

17. The system of claim 16, wherein the first presentation scan window is oriented horizontally and the second presentation scan window is oriented vertically.

18. The system of claim 15, wherein the operation of the presentation scanning apparatus is altered by processing data from the first presentation scan window before processing data from the second presentation scan window.

19. The system of claim 15, wherein the operation of the presentation scanning apparatus is altered by allotting more time attempting to decode data from the first presentation scan window than from the second presentation scan window.

20. The system of claim 15, wherein the operation of the presentation scanning apparatus is altered by performing more scan lines on the first presentation scan window than the second presentation scan window to increase the pattern density on the first presentation scan window.

21. The system of claim 20, wherein a reserve scan channel coupled to the first presentation scan window is activated by the central processing unit.

22. The system of claim 21, wherein one scan channel in the second presentation scan window is turned off for each reserve scan channel that is activated in the first presentation scan window.

23. The system of claim 20, wherein the central processing unit commands the first scanning mirror to divert scan lines from the first presentation scan window to the second presentation scan window.

24. The system of claim 1, wherein the presentation scanning apparatus defines a first presentation scan area to which objects can be presented for scanning and a second presentation scan area to which objects can be presented for scanning

25. The system of claim 24, wherein the second presentation scan area is defined orthogonally relative to the first presentation scan area.

26. The system of claim 24, wherein the operation of the presentation scanning apparatus is altered by processing data from the first presentation scan area before processing data from the second presentation scan area.

27. The system of claim 24, wherein the operation of the presentation scanning apparatus is altered by allotting more time attempting to decode data from the first presentation scan area than from the second presentation scan area.

28. The system of claim 24, wherein the operation of the presentation scanning apparatus is altered by performing more scan lines on the first presentation scan area than the second presentation scan area to increase the pattern density on the first presentation scan area.

29. The system of claim 24, wherein a reserve scan channel coupled to the first presentation scan area is activated by the system.

30. The system of claim 29, wherein one scan channel in the second presentation scan area is turned off for each reserve scan channel that is activated in the first presentation scan area.

31. The system of claim 24, wherein the presentation scanning apparatus commands the first scanning mirror to divert scan lines from the first presentation scan area to the second presentation scan area.
